(19) United States
(12) Patent Application Publication
(10) Pub. No.: US 2014/0017006 A1
(43) Pub. Date: Jan. 16, 2014

(54) PAVING MATERIAL

(71) Applicants: John Thomas Liddy, Claverly (GB); Paul Andrew Darby, Stourbridge (GB)

(72) Inventors: John Thomas Liddy, Claverly (GB); Paul Andrew Darby, Stourbridge (GB)

(21) Appl. No.: 14/006,946

(22) PCT Filed: Mar. 21, 2012
(86) PCT No.: PCT/GB2012/050613

§ 371 Date: Sep. 23, 2013

(30) Foreign Application Priority Data
Mar. 23, 2011 (GB) 1104858.4

(51) Int. Cl. C04B 26/12; E01C 11/02

(52) U.S. Cl. CPC C04B 26/125; E01C 11/02
USPC 404/73; 524/512; 524/44; 524/43; 524/320; 523/122; 524/492; 524/431; 524/413; 524/449; 524/5

(57) ABSTRACT

A paving material for filling gaps between paving blocks or the like, the paving material comprising a powdered or granulated mixture of: inert particulate; a water-soluble resin formable from a polymerisation reaction between formaldehyde and an at least difunctional nucleophile; and a water-soluble acid. The paving material is filled into gaps between blocks and then liquid water is applied thereto, or the sand is exposed to ambient humidity (gaseous water). Upon contact with the water, the resin coats the sand and then sets hard, thereby stabilising the block paving.

### BACKGROUND

The present invention relates to an improved paving material for use in block paving applications, clay paviors, slabs and other products in relation to the laying of paths, driveways, forecourts, patios and the like, or to any similar application where stability is required. Embodiments of the invention may also find utility for filling gaps between sections of runways and in various other heavy duty civil engineering applications.

When laying block paving, for example as part of a road or driveway, it is known to fill the gaps between adjacent blocks with kiln dried sand so as to provide structural stability to the blocks. However, ordinary kiln dried sand has the disadvantage that it tends to disperse and disappear from between the blocks, especially during wet and windy weather or when the road or driveway is being swept, leaving gaps between the blocks. These gaps eventually result in structural instability, since the blocks then become free to move with respect to each other. Furthermore, the block paved road or driveway becomes unsightly, and weeds may grow in the gaps between the blocks. Indeed, ordinary kiln dried sand allows weeds to grow between the blocks even when the gaps are filled with the sand.

It is known to provide a polymeric sealant to block paved roads or driveways after laying, which can help to ameliorate these problems, but the application of sealant is time consuming and expensive.

It is also known, for example from U.S. Pat. No. 5,244,304, JP 2285103 and JP 10265251, to provide a cementitious material including a polymer component for use in laying paving slabs and the like. These cementitious materials may be used as a base layer or as a jointing compound, but are disadvantageous in that once set, it is extremely difficult to clean up spillages and splashes which can cause staining of the paving slabs and the like. This is because cementitious materials tend to set permanently and cannot thereafter be removed without chipping or other physical force. These materials are also messy and unpleasant to apply, being in a paste-like cementitious form that is wholly unsuited as a jointing compound for block paving and the like. These materials are susceptible to cracking, and have a high environmental impact.

Other jointing compounds known, for example, from DE 4421970, WO 00/50355 and WO 97/07303, use mixtures of liquid polybutadiene, a flow enhancer and dry particulate material such as sand, crushed glass or fine aggregate. These mixtures are advantageous in that they are relatively easy to handle and do not adhere to paving slabs or the like when spilled thereon. However, the mixtures are designed to set upon exposure to air or oxygen, which can make handling difficult and means that the mixtures require careful storage. Furthermore, flow enhancers generally contain environmentally-unfriendly organic solvents. It will be appreciated that polybutadiene is not a water-soluble polymer.

A coloured asphaltic paving material is known from JP 61254701. This material comprises a resin emulsion, quartz sand pigment, silica asphalt emulsion, a thickening agent and a defoaming agent. This material is used in a manner similar to ordinary asphalt, being spread in fluid form onto a surface (e.g. a tennis court) and allowed to set. It is wholly unsuitable for use as a jointing compound for block paving, being messy to apply and requiring heating.

A block paving sand that solves many of the problems outlined above is known from WO 03/037817 in the names of the present inventors. This block paving sand comprises kiln dried sand mixed with a water-soluble polymer. However, experiments undertaken by the present applicants have shown that there is still some room for improvement.

A block paving sand that solves many of the problems outlined above is known from WO 2010/064029 in the names of the present inventors. This block paving sand comprises dried sand mixed with a water-soluble polymer and a metal hydroxide. However, experiments undertaken by the present applicants have shown that there is still some room for improvement.

### BRIEF SUMMARY OF THE DISCLOSURE

According to a first aspect of the present invention, there is provided a paving material for filling gaps between paving blocks or the like, the paving material comprising a powdered or granulated mixture of: inert particulate; a water-soluble resin formable from a polymerisation reaction between formaldehyde and an at least difunctional nucleophile; a water-soluble acid; and a water soluble polymer.

According to a second aspect of the present invention, there is provided a powdered or granulated paving material comprising, by weight: 10.2-12.4% sum weight of melamine formaldehyde and/or urea formaldehyde and/or phenol formaldehyde; 4.2% poly(vinyl acetate-ethylene) copolymer; 0.5% citric acid monohydrate; 0.5% diammonium phosphate; and the balance to 100% of dried sand.

According to a third aspect of the present invention, there is provided a powdered or granulated paving material comprising, by weight: 4.5% sum weight of melamine formaldehyde and/or urea formaldehyde and/or phenol formaldehyde; 4.5% poly(vinyl acetate-ethylene) copolymer; 0.3% citric acid monohydrate; 0.3% diammonium phosphate; and the balance to 100% of dried sand.

According to a fourth aspect of the present invention, there is provided an additive material for mixing with powdered or granulated inert particulate to form a paving material for filling gaps between paving blocks or the like, the additive material comprising a powdered or granulated mixture of: a water-soluble resin formable from a polymerisation reaction between formaldehyde and an at least difunctional nucleophile; a water-soluble acid; and a water soluble polymer.

According to a fifth aspect of the present invention, there is provided a method of stabilising paving blocks or the like comprising a plurality of blocks laid adjacent to each other with gaps therebetween, comprising: filling the gaps with a paving material for filling gaps between paving blocks or the like, the paving material comprising a powdered or granulated mixture of: inert particulate; a water-soluble resin formable from a polymerisation reaction between formaldehyde and an at least difunctional nucleophile; a water-soluble acid; and a water soluble polymer, and subsequently applying water to the paving material near upper surfaces of the blocks.

According to a sixth aspect of the present invention, there is provided a method of stabilising paving blocks or the like comprising a plurality of blocks laid adjacent to each other with gaps therebetween, comprising: mixing an additive material adapted for mixing with powdered or granulated inert particulate to form a paving material for filling gaps between paving blocks or the like, the paving material comprising a powdered or granulated mixture of: inert particulate; a water-soluble resin formable from a polymerisation reaction between formaldehyde and an at least difunctional nucleophile; a water-soluble acid and a water soluble polymer, with a powdered or granulated inert particulate to form a paving material, filling the gaps with the paving material, and subsequently applying water to the paving material near upper surfaces of the blocks.

According to an seventh aspect of the present invention, there is provided a use of a paving material for filling gaps between paving blocks or the like, the paving material comprising a powdered or granulated mixture of: inert particulate; a water-soluble resin formable from a polymerisation reaction between formaldehyde and an at least difunctional nucleophile; a water-soluble acid; and a water soluble polymer, characterised in that the paving material is applied to the gaps in dry form.

According to an eighth aspect of the present invention, there is provided a use of an additive material for mixing with powdered or granulated inert particulate to form a paving material for filling gaps between paving blocks or the like, the paving material comprising a powdered or granulated mixture of: inert particulate; a water-soluble resin formable from a polymerisation reaction between formaldehyde and an at least difunctional nucleophile; a water-soluble acid and a water soluble polymer, in the manufacture of a paving material for filling gaps between paving blocks or the like.

The powdered resin formable from a polymerisation reaction between formaldehyde and an at least difunctional nucleophile may be at least one material selected from a group consisting of melamine formaldehyde, urea formaldehyde, and phenol formaldehyde. Accordingly, the powdered resin formable from a polymerisation reaction between formaldehyde and an at least difunctional nucleophile may be melamine formaldehyde and/or urea formaldehyde and/or phenol formaldehyde. The powdered water-soluble resin formable from a polymerisation reaction between formaldehyde and an at least difunctional nucleophile, may be formable from a condensation polymerisation reaction. The powdered water-soluble resin formable from a polymerisation reaction between formaldehyde and an at least difunctional nucleophile, may be formable from a methylation polymerisation reaction.

For the avoidance of doubt, the expression “paving blocks or the like” in the context of the present application may encompass block paved roads or driveways or the like, clay paviors, slabs and any other products in relation to the laying of paths, driveways, forecourts (including petrol/gasoline station forecourts), patios, airport runways, roads and other civil engineering applications.

The powdered inert particulate may comprise dried sand. The dried sand may be kiln dried, or may be sand that has been allowed to dry naturally in the sun (for example in hot climates). The powdered inert particulate may comprise one or more components chosen from a group comprising: crushed glass; flint; aggregate (e.g. crushed limestone); and fly ash. The powdered inert particulate may have a mesh size (maximum particle size) of no more than 2 mm. The powdered inert particulate may have a mean average grain size of less than 1 mm.

The paving material may comprise up to 25% by weight of the powdered resin made from a polymerisation reaction between formaldehyde and an at least difunctional nucleophile. The paving material may comprise 2% to 25% by weight of the resin. The paving material may comprise 3% to 16% by weight of the resin. The paving material may comprise 3% to 7% by weight of the resin. The paving material may comprise 7% to 16% by weight of the resin. In the case that the resin is melamine formaldehyde and/or urea formaldehyde and/or phenol formaldehyde, the percentage by weight relates to a sum weight of the constituent parts.

The additive material may comprise up to 90% by weight of the powdered resin made from a polymerisation reaction between formaldehyde and an at least difunctional nucleophile. The paving material may comprise 20% to 90% by weight of the resin. The paving material may comprise 30% to 80% by weight of the resin. The paving material may comprise 60% to 75% by weight of the resin. Alternatively, the paving material may comprise 35% to 55% by weight of the resin. In the case that the resin is melamine formaldehyde and/or urea formaldehyde and/or phenol formaldehyde, the percentage by weight relates to a sum weight of the constituent parts.

Melamine formaldehyde, urea formaldehyde, and phenol formaldehyde are water soluble, and so are able to dissolve on exposure of the paving material of the present invention to liquid water or ambient humidity.

Conveniently melamine formaldehyde resin powder may be provided by use of the Dynea® Prefere (Dynomel) 4865 Melamine Powder Resin product. Alternatively, the melamine formaldehyde resin powder may be provided by use of H600 Hexion Speciality Chemicals™ product. Conveniently urea formaldehyde resin powder may be provide by use of the Maragite Maragon™ product. Conveniently, phenol formaldehyde resin powder may be provided by use of a novolac or resol phenolic resin.

The water-soluble polymer may be a polymer formed from one or more alkene monomers. The water-soluble polymer may be polyvinyl acetate. The water-soluble polymer may be selected from a group comprising: styrene maleic anhydride polymer, poly(2-butenedioic) acid, poly(methoxyethene); polyvinyl alcohol; styrene butadiene copolymer, acrylics, acrylic copolymers and mixtures thereof.

The water-soluble polymer may be selected from a group comprising: hydroxymethyl cellulose, hydroxyethyl cellulose.

The water-soluble polymer may be a copolymer formed from vinyl acetate and one or more other alkene monomers. The water-soluble polymer may be a vinyl acetate/versatate copolymer. The water-soluble polymer may be poly(vinyl-ethylene) copolymer.

Preferably, the paving material includes at least 2% by weight water-soluble polymer, and preferably no more than 25% by weight water-soluble polymer. In a particularly preferred embodiment, the paving material includes from 2% to 10% by weight water-soluble polymer. The water-soluble polymer is preferably dispersed throughout the dried sand as a fine powdered or granulated formulation.

Preferably, the additive material includes at least 10% by weight water-soluble polymer, and preferably no more than 80% by weight water-soluble polymer. In a particularly preferred embodiment, the additive material includes from 20% to 30% by weight water-soluble polymer. In an alternative particularly preferred embodiment, the additive material includes from 45% to 55% by weight water-soluble polymer. The water-soluble polymer is preferably dispersed throughout the dried sand as a fine powdered or granulated formulation.

The provision of a water-soluble polymer component in the paving material or additive material means that the application of water to the paving material, once it has been filled into the gaps between adjacent blocks, will tend to dissolve at least a part of the polymer component. The polymer solution will then tend to coat the sand particles, causing them to adhere to each other upon drying. Indeed, the water-soluble polymer is preferably chosen so as to cause the paving material to set solid after being wetted and subsequently dried, whilst also introducing flexibility. Water may be applied by way of a hosepipe or the like, or by way of natural rainfall.

In the presence of ambient humidity (gaseous water) or liquid water, and the acid promotes cross-linking of the polymer, for example through a condensation reaction. Advantageously, cross-linking prevents rehydration of the polymer, and consequently prevents the polymer from being washed away, by further rainfall. The acid facilitates cross-linking of the polymer at ambient temperatures.

The water-soluble (powdered or granulated) acid may be citric acid, tartaric acid, oxalic acid, succinic acid, para toluene sulphonic acid or any water-soluble organic or inorganic powdered acid. The water-soluble acid may be an acid hydrate. Advantageously, citric acid occurs naturally in plants, and decomposes in the atmosphere, so its use in the paving material of the present invention has a low environmental impact.

Particularly preferred polymers for use with embodiments of the present invention are poly(vinyl acetate-ethylene) copolymers such as those sold under the SAFIX 300® brand. Other suitable polymers include the AkzoNobel ELOTEX® FX2300 range of redispersible binders based on a copolymer of vinyl acetate and ethylene, with polyvinyl alcohol as a protective colloid and mineral anti-block agents, e.g. kaolin, as additives. The FX2320 member of the FX2300 product family has been found to be effective.

The water-soluble polymer component advantageously comprises grains or particles coated with a solubilising agent which, upon contact with water, enhances the solubility of the polymer component in the water. Alternatively, a separate powdered or granulated solubilising agent may be included within the mixture. Because the solubilising agent will tend gradually to be washed away from exposed regions of the paving material subject to repeated rainfall or wetting, the set polymer component in these regions will tend to be relatively insoluble and thus will remain relatively stable, becoming more and more so over time. Advantageously the AkzoNobel ELOTEX® FX2300 products comprise a solubilising agent.

Advantageously, a degree of elastomeric flexibility may be retained so as to allow for thermal expansion and mechanical deformation due to heavy vehicles passing over the block paving, and any cracks or defects in the paving material once laid will tend to be self-healing upon subsequent rainfall or wetting.

Alternative polymers suitable for use with the present invention include polyvinyl family polymers such as polyvinyl acetate, polyvinyl alcohol, and vinyl acetate/versatate copolymer (for example that sold under the trade names of RHOXIMAT® PAV 33 or RHOXIMAT® PAV 43), styrene maleic anhydride polymer, styrene butadiene copolymer (with an optional kaolin filler, for example as sold under the trade name of RHOXIMAT® PSB 150), hydroxymethyl cellulose, hydroxyethyl cellulose, poly(2-butenedioic) acid, poly(methoxyethene), acrylics, acrylic copolymers and mixtures thereof. It will be appreciated that other water-soluble polymers may be effective.

The polymer component is preferably mixed in with the other components as a powdered or granulated formulation.

Preferably, the paving material is a non-cementitious and/or non-asphaltic material. In particular, preferred embodiments of the present invention do not contain Portland cement. However, in some embodiments a small amount of cement and/or pozzolan, for example Portland cement, may be included in the mixture.

The paving material or additive material of preferred embodiments of the present invention is non-cementitious (i.e. does not contain Portland cement), at least not in an amount substantial enough to cause the paving material (or additive material, in use) to set in a cementitious manner, and non-asphaltic (i.e. does not contain asphalt or asphalt-like components). The paving material (or additive material, in use) is preferably applied in a dry powdered or particulate form, and may thus easily be swept or otherwise applied into interstitial gaps in block paved surfaces or the like. Because the paving material does not set until gaseous or liquid water is applied and can safely be exposed to dry air or oxygen without setting, it is easy to store and handle.

Alternatively, the paving material or additive material may comprise cement or pozzolan. Where present, the amount of cement and/or pozzolan in the paving material of the present invention may be less than 5% by weight, up to 4% by weight, preferably up to 2% by weight, and most preferably up to 1% by weight. The paving material of the present invention may comprise at least 0.1% by weight cement and/or pozzolan. The addition of cement and/or pozzolan helps to accelerate the setting of the paving material (or additive material, in use) after application, but too much cement will lead to the problems outlined previously. Moreover, cement is not an environmentally-friendly material, and it is preferred to avoid or at least minimize its use.

Preferably the additive material or paving material of the present invention does not contain herbicide and/or fungicide. Alternatively, the additive or paving material of the present invention may include herbicide and/or fungicide (for example ACTICIDE® EP powder).

The paving or additive material of the present invention may not contain colorants or dyes.

Alternatively, the paving material or additive material may comprise one or more colorants or dyes. The colorant or dye may comprise carbon black, green sand, black iron oxide, grey mica pearl, copper spinel, and/or copper oxide.

The paving material or additive material of the present invention may comprise a powdered or granulated acid support chemical, which supports the operation of the acid in cross-linking the polymer. The acid support chemical may be ammonium phosphate. The ammonium phosphate may be monoammonium phosphate, diammonium phosphate, triammonium phosphate, metal halides (e.g. aluminium chloride) or metal sulphates (e.g. aluminium sulphate).

Earlier variations of improved block paving sands produced by the inventors in respect of the present application have included powdered or crystalline water glass. For the avoidance of doubt, preferred embodiments of the present invention do not contain powdered or crystalline water glass.

### DETAILED DESCRIPTION

A first particularly preferred formulation for the paving material of the present invention is made up in the following relative proportions: 100 kg kiln dried sand; 12 to 15 kg melamine formaldehyde resin powder; 5 kg powdered poly(vinyl acetate-ethylene) copolymer with mineral anti-block agents and polyvinyl alcohol protective colloid; 0.6 kg citric acid powder; and 0.6 kg diammonium phosphate. This paving material is intended to be sold and applied in dry granulated or powdered form. This paving material is particularly suited for use in forming wide joints between paving blocks.

A second particularly preferred formulation for the paving material of the present invention is made up in the following relative proportions: 100 kg kiln dried sand; 5 kg melamine formaldehyde resin powder; 5 kg powdered poly(vinyl acetate-ethylene) copolymer with mineral anti-block agents and polyvinyl alcohol protective colloid; 0.3 kg citric acid powder; and 0.3 kg diammonium phosphate. This paving material is intended to be sold and applied in dry granulated or powdered form. This paving material is particularly suited for use in forming narrow joints between paving blocks.

In an alternative embodiment, the present invention is a water-soluble powdered or granulated additive material, which can be mixed with dried sand (or other powdered or granulated inert particulate) to form a paving material for filling gaps between paving blocks or the like. In particular, when so mixed, the additive material may form a paving material according to the preferred first or second formulation.

Thus, a first particularly preferred formulation for the additive material of the present invention is made up in the following relative proportions: 12 to 15 kg melamine formaldehyde resin powder; 5 kg powdered poly(vinyl acetate-ethylene) copolymer with mineral anti-block agents and polyvinyl alcohol protective colloid; 0.6 kg citric acid powder; and 0.6 kg diammonium phosphate.

A second particularly preferred formulation for the additive material of the present invention is made up in the following relative proportions: 5 kg melamine formaldehyde resin powder; 5 kg powdered poly(vinyl acetate-ethylene) copolymer with mineral anti-block agents and polyvinyl alcohol protective colloid; 0.3 kg citric acid powder; and 0.3 kg diammonium phosphate.

It is to be noted that the present invention is suitable not just for block paving applications, but for any application where blocks or slabs or the like are laid and require interstitial stabilisation.

The preferred features of the invention are applicable to all aspects of the invention and may be used in any possible combination.

Throughout the description and claims of this specification, the words “comprise” and “contain” and variations of the words, for example “comprising” and “comprises”, mean “including but not limited to”, and are not intended to (and do not) exclude other components, integers, moieties, additives or steps.

1. A paving material for filling gaps between paving blocks or the like, the paving material comprising a powdered or granulated mixture of:
inert particulate;
a water-soluble resin formable from a polymerisation reaction between formaldehyde and an at least difunctional nucleophile;
a water-soluble acid; and
a water soluble polymer.

2. A paving material as claimed in claim 1, wherein the resin is at least one material selected from a group consisting of: melamine formaldehyde, urea formaldehyde, and phenol formaldehyde.

3. A paving material as claimed in claim 1 or claim 2, wherein the inert particulate comprises dried sand.

4. A paving material as claimed in claims 1 2, or 3, wherein the inert particulate comprises one or more components chosen from a group comprising: crushed glass; flint; aggregate; and fly ash.

5. A paving material as claimed in any preceding claim, comprising up to 25% by weight resin.

6. A paving material as claimed in any preceding claim, comprising from 2% to 25% by weight resin.

7. A paving material as claimed in claim 6, comprising from 3% to 16% by weight resin.

8. A paving material as claimed in claim 7, comprising from 3% to 7% by weight resin.

9. A paving material as claimed in claim 6, comprising from 7% to 16% by weight resin.

10. A paving material as claimed in any preceding claim, comprising from 2% to 25% by weight water-soluble polymer.

11. A paving material as claimed in claim 10, comprising from 2% to 10% by weight water-soluble polymer.

12. A paving material as claimed in any preceding claim, wherein the water-soluble polymer is a polymer formed from one or more alkene monomers.

13. A paving material as claimed in claim 12, wherein the water-soluble polymer is polyvinyl acetate.

14. A paving material as claimed in claim 12, wherein the water-soluble polymer is selected from a group comprising: styrene maleic anhydride polymer, poly(2-butenedioic) acid, poly(methoxyethene); polyvinyl alcohol; styrene butadiene copolymer, acrylics, acrylic copolymers and mixtures thereof.

15. A paving material as claimed in claim 12, wherein the water-soluble polymer is a copolymer formed from vinyl acetate and one or more other alkene monomers.

16. A paving material as claimed in claim 15, wherein the water-soluble polymer is a vinyl acetate/versatate copolymer.

17. A paving material as claimed in claim 15, wherein the water-soluble polymer is poly(vinyl-ethylene) copolymer.

18. A paving material as claimed in any of claims 1 to 11, wherein the water-soluble polymer is selected from a group comprising: hydroxymethyl cellulose, hydroxyethyl cellulose.

19. A paving material as claimed in any preceding claim, comprising from 0.1% to 6% by weight acid.

20. A paving material as claimed in claim 19, comprising from 0.2% to 1% by weight acid.

21. A paving material as claimed in claim 20, comprising from 0.2% to 0.4% by weight acid.

22. A paving material as claimed in claim 19, comprising from 0.4% to 1% by weight acid.

23. A paving material as claimed in any preceding claim, wherein the acid is citric acid monohydrate.

24. A paving material as claimed in any preceding claim, further comprising an acid support chemical, which supports operation of the acid in cross-linking the polymer.

25. A paving material as claimed in any preceding claim, further comprising a herbicide and/or fungicide.

26. A paving material as claimed in any preceding claim, further comprising a colorant or dye.

27. A paving material as claimed in claim 26, wherein the colorant or dye is at least one material selected from a group consisting of: carbon black, green sand, black iron oxide, grey mica pearl, copper spinel, and copper oxide.

28. A paving material as claimed in any preceding claim, wherein the paving material is substantially non-cementitious.

29. A paving material as claimed in any one of claims 1 to 27, comprising cement and/or pozzolan.

30. A paving material as claimed in claim 29, comprising at least 0.1% by weight of cement and/or pozzolan.

31. A paving material as claimed in claims 29 or 30, comprising up to 4% by weight of cement and/or pozzolan.

32. A paving material as claimed in claim 1, the paving material comprising, by weight: 82.5-85.6% dried sand; 10.2-12.4% melamine formaldehyde and/or urea formaldehyde; 4.2% poly(vinyl acetate-ethylene) copolymer; 0.5% citric acid monohydrate; and 0.5% ammonium phosphate.

33. A paving material as claimed in claim 1, the paving material comprising, by weight: 90.4% dried sand; 4.5% melamine formaldehyde and/or urea formaldehyde; 4.5% poly(vinyl acetate-ethylene) copolymer; 0.3% citric acid monohydrate; and 0.3% ammonium phosphate.

34. A paving material as claimed in any preceding claim, wherein the paving material is in dry, particulate, free-flowing form.

35. A paving material for filling gaps between paving blocks or the like substantially as hereinbefore described.

36. An additive material for mixing with powdered or granulated inert particulate to form a paving material according to any preceding claim; the additive material comprising a powdered or granulated mixture of:
a water-soluble resin formable from a polymerisation reaction between formaldehyde and an at least difunctional nucleophile;
a water-soluble acid; and
a water soluble polymer.

37. A method of stabilising paving blocks or the like comprising a plurality of blocks laid adjacent to each other with gaps therebetween, comprising:
filling the gaps with a paving material as claimed in any one of claims 1 to 35, and subsequently
applying water to the paving material near upper surfaces of the blocks.

38. A method of stabilising paving blocks or the like comprising a plurality of blocks laid adjacent to each other with gaps therebetween, comprising:
mixing an additive as claimed in claim 36 with a powdered or granulated inert particulate to form a paving material,
filling the gaps with the paving material, and subsequently
applying water to the paving material near upper surfaces of the blocks.

39. A method of stabilising paving blocks or the like comprising a plurality of blocks laid adjacent to each other with gaps therebetween, substantially as hereinbefore described.

40. Use of a paving material as claimed in any one of claims 1 to 35 for filling gaps between paving blocks or the like, characterised in that the paving material is applied to the gaps in dry form.

41. Use according to claim 40, wherein water is applied to the paving material after the gaps have been filled.

42. Use of an additive material as claimed in claim 36 in the manufacture of a paving material for filling gaps between paving blocks or the like.
